(19) United States
(12) Patent Application Publication
(10) Pub. No.: US 2002/0166451 A1
(43) Pub. Date: Nov. 14, 2002

(54) Vessel for heating liquids without delay in boiling

(76) Inventors: Horst Rothe, Nerkewitz (DE); Zoltan Csonka, Sopron (HU); Laszlo Csonka, Sopron (HU)

Correspondence Address: BAKER & DANIELS, 111 E. WAYNE STREET, SUITE 800, FORT WAYNE, IN, 46802

(21) Appl. No.: 10/074,332

(22) Filed: Feb. 12, 2002

(30) Foreign Application Priority Data
Feb. 15, 2001 (DE) 101 07 498.0

(51) Int. Cl. A23L 1/00

(52) U.S. Cl. 99/275

(57) ABSTRACT

The following invention concerns a vessel for heating liquids without delay in boiling whereby at least one foreign material is applied, at least at one location on the inner surface of the vessel. The present invention further concerns a process for manufacturing a vessel for heating liquids without delay in boiling, wherein at least one of the following materials, colors, glass and porcelain colors, glue, adhesive, gluten or polymers is applied to the inner surface the vessel by means of a painter's brush, swab, screen printing or as a decal. The present invention concerns ultimately the use of the vessel for heating of liquids without delay in boiling, for all processes in which liquids, especially water, are heated, in the household domain, especially in household utensils, in industrial domains, especially in the chemical industry, and in the laboratory.

The present invention concerns a vessel for heating liquids without delay in boiling.

The usual apparatus for heating liquids in industry, in the laboratory, and especially in the household suffers the drawback that, especially when heating-up water, an unexpected delay in boiling occurs. That is dangerous, especially in the domestic domain, in the kitchen, where it frequently causes serious burns. Manufacturers of household utensils have attempted for a long time to make heating apparatus, such as hot water kettles, that don't give rise to a delay in boiling.

The object of the present invention is a vessel in which a liquid may be heated without delay in boiling, and an environmentally acceptable commercial process for manufacturing such vessels.

The problem of the present invention, to devise a vessel for heating a liquid without delay in boiling, is solved whereby at least one foreign material is applied to at least one location on the inside surface of the vessel, and at most on the entire inside surface of the vessel. The advantage of vessels for heating liquids, made according to the invention, lies in the fact that dangerous delay in boiling is prevented. The vessels can be of any usually desired shape or form, and are suited for any usually desired quantities of liquid.

A preferred embodiment of the invention is a vessel whereby the place at which the foreign material is applied measures 0.1 mm to 50 mm. With these dimensions good results are obtained. Good bubble formation is observed.

A preferred embodiment of the invention is a vessel, wherein the applied foreign material contains at least one of the following materials, colors, glass colors, porcelain colors, adhesives, glue, gluten, tissue, textiles, inorganic and organic polymers or mixtures thereof. With these materials very good results are obtained.

A preferred embodiment of the invention is a vessel whereby the foreign material is applied by means of painters brushes, swabs, screen printing, adhesives, melting together, slide or decal. With these processes good results are obtained.

A preferred embodiment of the invention is a vessel whereby the inner surface of the vessel contains at least one of the following constituents, such as glass especially borosilicate glass, glass ceramic, ceramic, enamel, metal, metal alloy, inorganic and organic polymes or mixtures thereof. According to the invention, commercially available, cost effective and environmentally friendly foreign materials are utilized.

According to the invention, a process for manufacture of a vessel for the purpose of heating liquids without delay in boiling is provided for, whereby, at least one of the following materials, colors, glass and porcelain colors, glue, adhesive, gluten, or polymers are applied by means of painters brushes, swabs, screen printing, slide or decal, on the inside surface of the vessel. According to the invention, the foreign material is applied cost effectively and in an environmentally friendly manner. According to the invention, the process for manufacturing a vessel for heating a liquid without delay in boiling is foreseen for all processes in which liquids, especially water, are heated.

According to the invention, a vessel for heating liquids without delay in boiling is intended in household use, especially for household appliances, in industry especially in the chemical industry, in the medical domain, and in the laboratory.

According to the invention, the use of a vessel for heating liquids without delay in boiling is intended for all heating sources, especially burners, electric hearths, gas hearths, microwave equipment, ceramic and glass ceramic heating plates. It would be particularly suitable for ceramic cooking ranges, like the Ceran® cooking range.

The invention is explained in further detail by means of figures and examples.

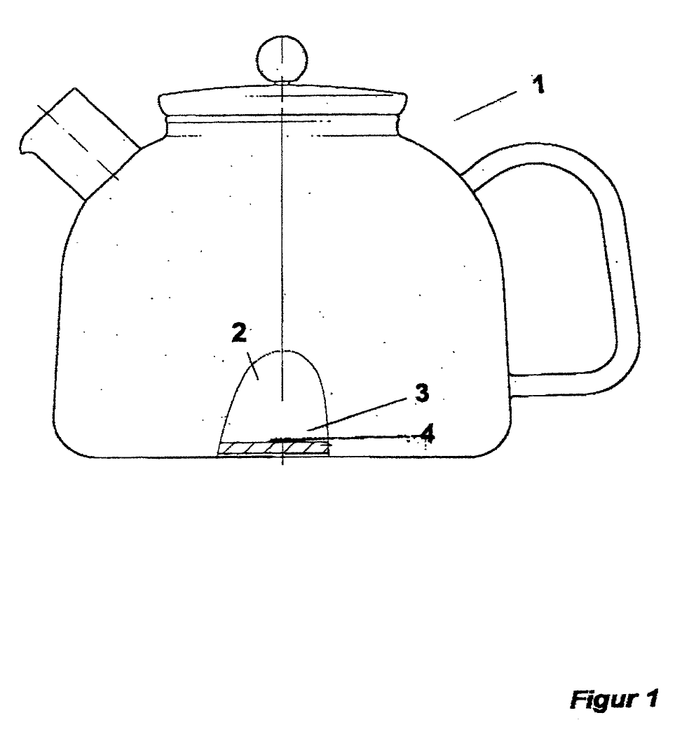

FIG. 1 shows a water kettle (1) with a cut-out (2) at the base (3) where a color-form (4) is shown.

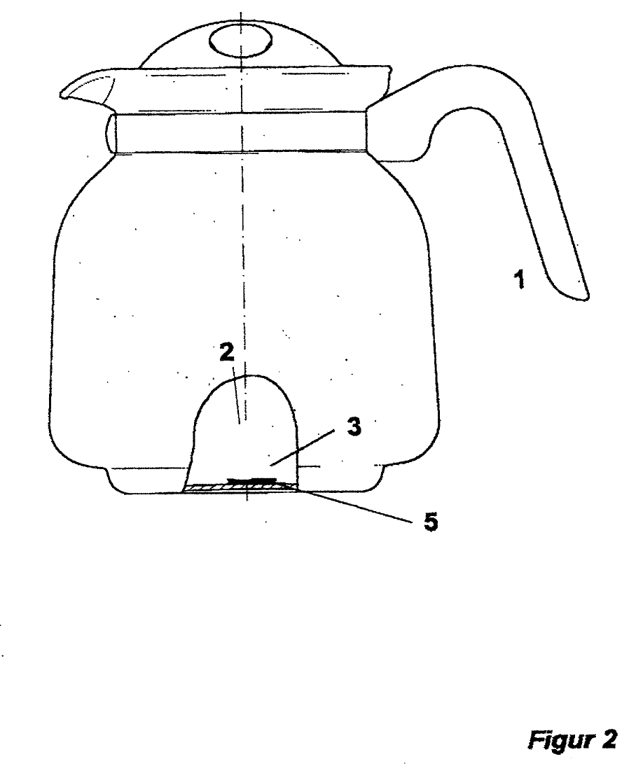

FIG. 2 shows a water kettle with a cut-out (2) at the base (3) where a decal (5) is shown.

### EXAMPLES

The following general comments apply to the use of Color Series H 52 from Heräus. The Colors of Series H 52 are miscible with each other. The paste should be homogenized by means of a three-roll mill. This is especially important since matte or rough dye surfaces are mostly caused by insufficient dye dispersion. Homogenization by means of a three-roll mill is important for direct screen printing and transfer preparation. In screen printing and with decals, a mix containing 100 parts by weight of color powder to 55 parts by weight of screen print oil is used. After the transfer has been dried for 4 to 5 hours, slowly increasing the burning-in temperature, and maintaining good ventilation, especially in the initial burning-in stage up to about 300° C., a clear indication for the quality of the finished decorated article will be evident.

### Example 1

A glass color (Heräus, Series H 52) was applied using a painters brush to the middle of the base of a glass vessel. That point had a thickness of 5 mm. The color was then fired as prescribed. When heating water, bubbles were clearly seen to be formed. There was no delay in boiling.

### Example 2

A glass color was evenly applied to the middle of the base of a glass vessel as a decal. The surface of the decal was 10 mm×300 mm. The color was fired as prescribed. When heating water, the formation of bubbles was clearly seen. There was no delay in boiling.

The advantages of the present invention were shown by means of the preceding examples.

1. A vessel for heating liquids without delay in boiling, whereby, at least one foreign material is applied, at the least at one location on the inner surface of the vessel, or at most, on the entire inner surface of the vessel.

2. The vessel according to claim 1, whereby the location where the foreign material is applied measures 0.1 mm up to 50 mm.

3. The vessel according claim 1 or 2 whereby the foreign material is applied at the base.

4. The vessel according to one or more of claims 1 through 3, whereby the foreign material that is utilized is at least one of the following materials, a color, glass color, porcelain color, adhesive, glue, gluten, textiles, tissue, inorganic or organic polymers or a mixture thereof.

5. The vessel according to one or more of claims 1 through 4 whereby the foreign material is applied by means of painters brushes, swabs, printing, adhesives, melting together, slide, or decal.

6. The vessel according to one or more of claims 1 through 5 whereby the inner surface of the vessel contains at least one of the following constituents, glass, especially borosilicate glass, glass ceramic, ceramic, porcelain, enamel, metal, metal alloy, inorganic and organic polymers, or mixtures thereof.

7. Process for the manufacture of a vessel for heating liquids without delay in boiling, according to one or several of claims 1 through 6 whereby at least one of the following materials is applied to the inner surface of the vessel, color, glass color, porcelain color, adhesive, glue, gluten, textiles, tissues, inorganic or organic polymers or mixtures thereof, by means of painters brushes, swabs, printing, adhesives, melting together, slide, or decal.

8. Utilization of a vessel for heating of liquids without delay in boiling, according to one or several of claims 1 through 6, for all processes by which liquids, especially water, are heated.

9. Utilization of a vessel for heating liquids without delay in boiling, according to one or more of claims 1 through 8, in the household domain, especially household appliances, in the industrial domain, especially in the chemical industry, in the medical domain and in the laboratory.

10. Utilization of a vessel for heating of liquids without delay in boiling, according to one or several of claims 1 through 6 for all heat sources, especially burners, electric hearths, gas hearths, microwave appliances, as well as ceramic and glass ceramic heating plates.
